(19) United States
(12) Patent Application Publication
(10) Pub. No.: US 2018/0242410 A1
(43) Pub. Date: Aug. 23, 2018

(54) COOKING DEVICE

(71) Applicant: Panasonic Intellectual Property Management Co., Ltd., Osaka (JP)

(72) Inventors: Hirohisa Imai, Shiga (JP); Gantetsu Matsui, Kyoto (JP)

(21) Appl. No.: 15/944,441

(22) Filed: Apr. 3, 2018

Related U.S. Application Data
(63) Continuation of application No. PCT/JP2016/004699, filed on Oct. 26, 2016.

(30) Foreign Application Priority Data
Nov. 5, 2015 (JP) 2015-217250

(51) Int. Cl. H05B 6/68; H05B 6/64; H05B 6/66; H05B 6/74; H05B 6/70

(52) U.S. Cl. CPC H05B 6/687; H05B 6/6447; H05B 6/681; H05B 6/745; H05B 6/70; H05B 6/668

(57) ABSTRACT

In a heating cooker, when an image of an inside of heating compartment (12) is captured by imaging unit (19) before heating, controller (100) determines whether or not the image can be recognized by recognition unit (103). When the image cannot be recognized by recognition unit (103), controller (100) determines that capturing cannot be performed due to existence of a blade portion of stirrer blade (14a) in front of imaging unit (19), and drives motor (15a) by controlling rotation controller (102) thus rotating stirrer blade (14a) by a predetermined angle.

### TECHNICAL FIELD

The present invention relates to a heating cooker for heating a food item.

### BACKGROUND ART

A microwave oven which is one example of a heating cooker can heat a food item in a state where the food item is placed in a container without using a pot or a frying pan. Accordingly, in sales stores such as convenience stores, there are also services in which a food item such as a prepared meal and a side dish is heated by using a microwave oven and the heated food item is provided.

Usually, an optimum heating time for heating by a microwave oven is indicated on a prepared meal or a side dish. In general, a store employee in a sales store looks at the indication and sets a heating time in the microwave oven.

To be more specific, the store employee can set the heating time by operating number keys arranged on an operating part of the microwave oven. Further, when the store employee uses a microwave oven having a plurality of cooking buttons corresponding to heating times and wattage, the store employee can perform heating suitable for a food item to be heated by operating the button corresponding to the food item to be heated.

However, there exists a drawback that an operation of setting a heating time with number keys is cumbersome. Further, in a microwave oven where heating times of different food items are allocated to a plurality of operation buttons respectively, it is necessary for a store employee to memorize a correspondence relationship between the plurality of operation buttons and the food items. Accordingly, there exists a drawback that the larger the number of kinds of products, the larger a burden imposed on the store employee to memorize the correspondence relationship becomes.

To overcome such a drawback, it may be possible to provide a microwave oven which heats a product in accordance with a heating controlling content which corresponds to a bar code attached to the product by allowing a store employee to read information of the bar code.

Alternatively, there has been also disclosed a technique where a camera which captures an image of the inside of a heating compartment of a microwave oven is mounted on an ceiling surface in the heating compartment, a bar code portion is picked up from an image of a product put in the inside of the heating compartment, the bar code is read and a heating controlling content which corresponds to the product is read from code information, and proper heating is performed (see PTL 1, for example).

In general, a microwave oven which is used for a heating service in a sales store which handles prepared meals and side dishes includes a plurality of magnetrons for heating the prepared food or the side dish within a short time. In the microwave oven, the magnetrons are arranged on upper and lower sides in the heating compartment so that the prepared food or the side dish is heated from above and below.

Further, the microwave oven used in the sales store is configured such that microwaves are stirred by rotating a stirrer blade for improving heating distribution.

Accordingly, when a camera is mounted on the ceiling surface in the heating compartment in the vicinity of the center of the ceiling surface, an area in front of the camera is blocked by the stirrer blade so that there may be a case where an image of the inside of the heating compartment cannot be captured.

To overcome such a drawback, it may be possible to capture the image of the inside of the heating compartment obliquely from an end of the heating compartment by the camera mounted at the end. However, when the image of the inside of the heating compartment is captured by the camera from the end of the heating compartment, an area close to an end of the heating compartment on a side opposite from the camera mounted at the end is remote in distance from the camera so that the area is captured small and, at the same time, a capturing angle becomes shallow so that the deformation of image is large. Accordingly, the recognition of the captured image becomes difficult.

Further, when the image of the inside of the heating compartment is captured from the end of the heating compartment, the difference in distance between a side close to the camera and a side remote from the camera is large so that it is difficult to focus the camera on both sides whereby the recognition of a captured image also becomes difficult.

### CITATION LIST

### Patent Literature

PTL 1: Unexamined Japanese Patent Publication No. 2001-349546

### SUMMARY OF THE INVENTION

The present invention has been made to overcome such drawbacks, and it is an object of the present invention to provide a microwave oven having a stirrer blade on a ceiling surface in an inside of a heating compartment and capable of recognizing a product, a character, and the like with certainty even when a camera is arranged at an approximately center of a ceiling in the microwave oven.

To be more specific, a heating cooker according to one example of an exemplary embodiment of the present invention includes: a heating compartment; a magnetron which outputs a microwave; and a stirrer blade which is configured to stir the microwave and has a blade portion. Further, the heating cooker according to one example of the exemplary embodiment of the present invention includes: an imaging unit which captures an image of the inside of the heating compartment; and a controller having a function of recognizing the image captured by the imaging unit. The controller is configured to perform a control of rotating the stirrer blade by a predetermined angle or moving the stirrer blade to an initial position based on the image captured by the imaging unit.

With such a configuration, in a state where the stirrer blade blocks a field of view of the imaging unit when the image of the inside of the heating compartment is captured by the imaging unit before heating, it is possible to bring about a state where the image of the inside of the heating compartment can be captured by the imaging unit by rotating the stirrer blade. Accordingly, in the heating cooker having the stirrer blade on the ceiling surface in the inside of the heating compartment, a product, a character, and the like can be captured with more certainty even when the camera is arranged approximately at the center of the ceiling in the microwave oven. Accordingly, it is unnecessary for a user to perform a cumbersome operation such as setting of a heating time or the like.

### BRIEF DESCRIPTION OF DRAWINGS

FIG. 1 is an external appearance perspective view of a heating cooker according to a first exemplary embodiment and a second exemplary embodiment of the present invention.

FIG. 2 is a schematic view showing a configuration of the heating cooker according to the first exemplary embodiment and the second exemplary embodiment of the present invention.

FIG. 3 is a view showing one example of product information including heating control information indicated on a product according to the first exemplary embodiment and the second exemplary embodiment of the present invention.

FIG. 4 is a plan view of a stirrer blade of the heating cooker according to one example of the exemplary embodiment of the present invention.

FIG. 5 is a flowchart showing a flow of the manner of operation of the heating cooker according to the first exemplary embodiment of the present invention.

FIG. 6 is a flowchart showing a flow of the manner of operation of the heating cooker according to the second exemplary embodiment of the present invention.

### DESCRIPTION OF EMBODIMENT

### First Exemplary Embodiment

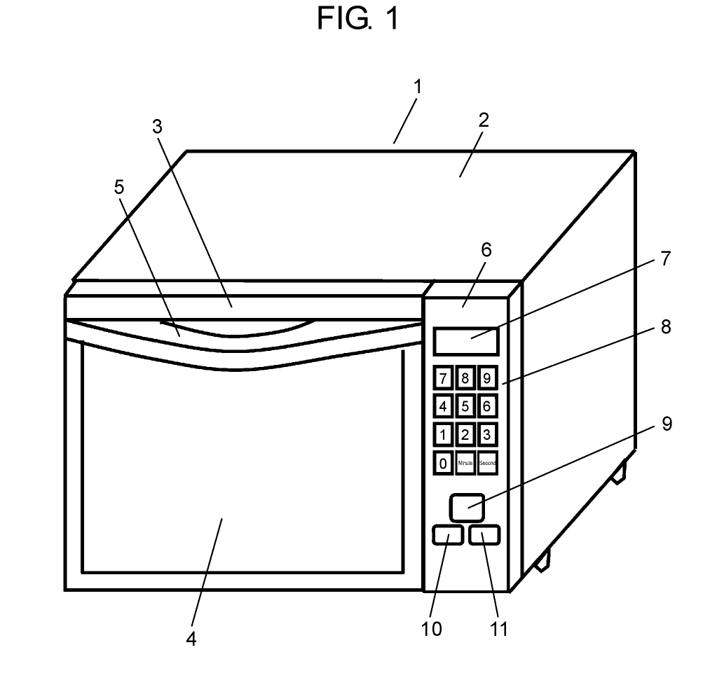

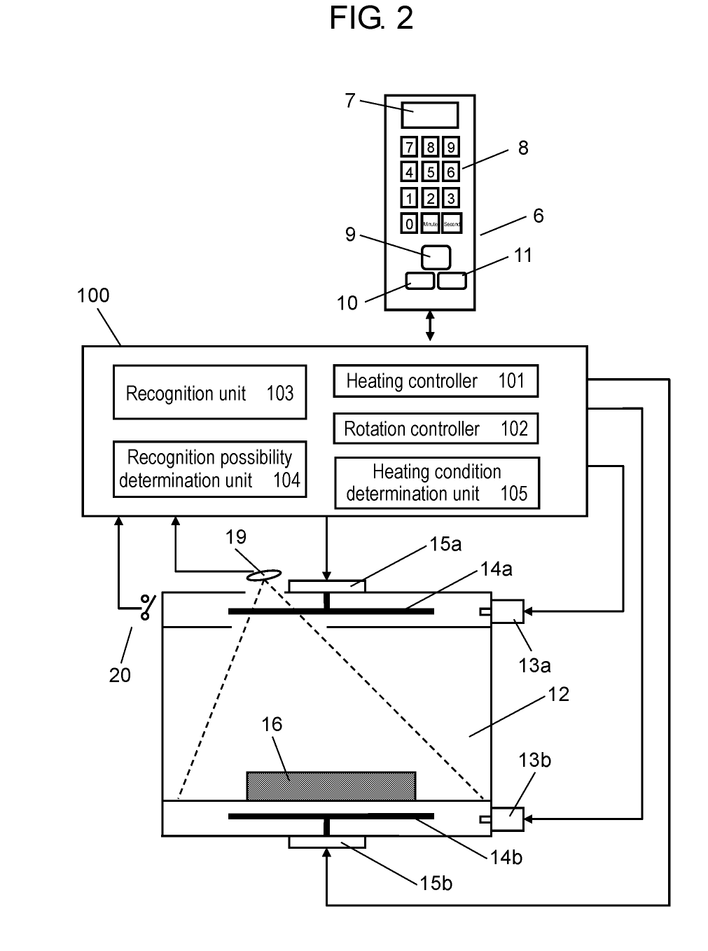

FIG. 1 is an external appearance schematic view of a heating cooker according to a first exemplary embodiment of the present invention. FIG. 2 is a schematic view showing a configuration of the heating cooker according to the first exemplary embodiment of the present invention.

As shown in FIG. 1, microwave oven 1 which is one example of a heating cooker according to the first exemplary embodiment of the present invention includes casing 2, and door 3 which is pivotally supported by casing 2 in an openable manner.

Door 3 includes transparent glass window 4 for allowing a user to visually recognize the inside of casing 2. Further, door 3 also includes handle 5 for allowing a user to easily hold door 3.

Operation display part 6 is arranged adjacent to door 3. Operation display part 6 includes liquid crystal display unit 7, a group of time setting buttons 8, heating start button 9, cancel button 10, and temporarily stop button 11.

Microwave oven 1 of this exemplary embodiment is configured such that imaging unit 19 captures a product which is an object to be heated, recognition unit 103 recognizes a heating control method indicated on the product, and a heating unit heats the product in accordance with the heating control method. On liquid crystal display unit 7, a heating control method which recognition unit 103 recognizes (for example, a heating time, wattage, and the like) is displayed.

However, there may be a case where recognition unit 103 cannot accurately recognize a heating control method and a case where a product for which a heating time is not indicated is heated.

Accordingly, microwave oven 1 of this exemplary embodiment includes the group of time setting buttons 8. With such a configuration, a user can set a heating time by using number buttons, buttons for setting minutes and seconds, and the like in the group of time setting buttons 8. Further, liquid crystal display unit 7 displays a set heating time and the like.

Heating start button 9 is a button for starting heating after a user is informed of a heating time, wattage, and the like by liquid crystal display unit 7. Cancel button 10 is a button for stopping heating after heating start button 9 is pushed and heating is started, or for canceling setting of a heating time displayed on liquid crystal display unit 7.

Temporarily stop button 11 is a button for temporarily stopping heating in the course of heating. Thus, a user can perform remaining heating from the midst of the course of heating by pushing heating start button 9 again after heating is temporarily stopped.

Microwave oven 1 includes two magnetrons 13a, 13b which output a microwave into the inside of heating compartment 12 which stores a food item and the like.

Magnetron 13a is arranged on a ceiling side of heating compartment 12, and outputs a microwave into the inside of heating compartment 12 from an upper portion. On the other hand, magnetron 13b is arranged on a bottom surface side of heating compartment 12, and outputs a microwave into the inside of heating compartment 12 from a lower portion.

Stirrer blade 14a is arranged on a ceiling side of heating compartment 12, and stirrer blade 14b is arranged on a bottom surface side of heating compartment 12.

When stirrer blade 14a is rotated, a microwave outputted from magnetron 13a is uniformly dispersed in the inside of heating compartment 12.

When stirrer blade 14b is rotated, a microwave outputted from magnetron 13b is uniformly dispersed in the inside of heating compartment 12.

Imaging unit 19 is arranged on a ceiling side of heating compartment 12. Imaging unit 19 is formed of an imaging element such as a Charge Coupled Device (CCD), for example, and captures the image of the inside of heating compartment 12.

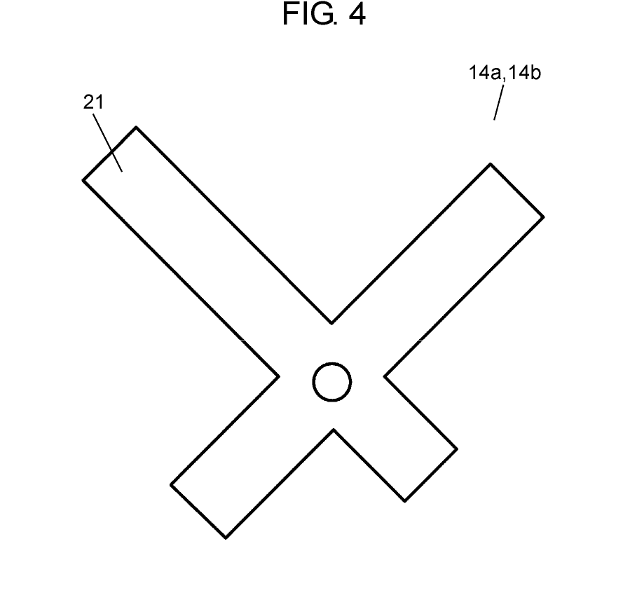

Imaging unit 19 is arranged above a rotating region of blade portion 21 of stirrer blade 14a (see FIG. 4 described later).

When imaging unit 19 captures an image of a food item (product) in the inside of heating compartment 12, a bar code, a character, and the like described on a surface of a food item can be captured with certainty by capturing the food item from right above compared to a case where the food item is captured obliquely. For such a reason, imaging unit 19 is arranged on a ceiling side of heating compartment 12, to be more specific, is arranged close to a rotary shaft of stirrer blade 14a disposed on a ceiling of heating compartment 12. Preferably, imaging unit 19 is arranged in a vicinity of an area right above a position where a product is placed (including the area right above the position) in the inside of heating compartment 12 and a position in the vicinity of the rotary shaft of stirrer blade 14a. In this embodiment, for example, imaging unit 19 is arranged adjacent to motor 15a described later. However, provided that a bar code, characters, and the like described on a surface of a food item can be captured with certainty, the position of imaging unit 19 is not particularly limited to such a position.

When a microwave impinges on imaging unit 19, imaging unit 19 is broken. Accordingly, when a food item is heated, an openable shutter or the like may be arranged between imaging unit 19 and heating compartment 12 such that imaging unit 19 is not exposed to the inside of heating compartment 12. Further, imaging unit 19 may be configured to be movable (for example, rotatable or the like) such that imaging unit 19 is not exposed to the inside of heating compartment 12 when a food item is heated.

Door switch 20 is a switch for detecting opening or closing of door 3.

Controller 100 controls respective circuits of microwave oven 1, and is constituted of a microcomputer such as a Central Processing Unit (CPU) or the like, for example.

Controller 100 includes heating controller 101, rotation controller 102, recognition unit 103, and recognition possibility determination unit 104. Controller 100 may include heating condition determination unit 105 described later.

In other words, it is also safe to say that controller 100 executes functions of heating controller 101, rotation controller 102, recognition unit 103, and recognition possibility determination unit 104 (and a function of heating condition determination unit 105 when controller 100 includes heating condition determination unit 105).

In this exemplary embodiment, the configuration is exemplified where heating controller 101, rotation controller 102, recognition unit 103, recognition possibility determination unit 104, and heating condition determination unit 105 are arranged in the inside of controller 100. However, these components may be constituted of semiconductor elements separate or individual from each other. Alternatively, among heating controller 101, rotation controller 102, recognition unit 103, recognition possibility determination unit 104, and heating condition determination unit 105, some constitutional elements may be arranged in the inside of controller 100 and remaining other constitutional elements may be arranged outside controller 100.

Heating controller 101 controls magnetron 13a and magnetron 13b.

Rotation controller 102 controls the rotation of stirrer blade 14a and stirrer blade 14b.

Stirrer blade 14a is connected to motor 15a, and stirrer blade 14b is connected to motor 15b. Rotation of stirrer blade 14a and stirrer blade 14b can be controlled by controlling motor 15a and motor 15b by rotation controller 102.

In this exemplary embodiment, when a user places a food item 16 on a bottom portion of heating compartment 12 and performs a heating starting operation, a microwave is outputted from magnetron 13a and magnetron 13b respectively, and the microwave is uniformly dispersed in the inside of heating compartment 12 due to the rotation of stirrer blade 14a and stirrer blade 14b.

Accordingly, unlike an ordinary household microwave oven, it is unnecessary to arrange a turn table, which rotates while a food item is placed thereon, on an inner bottom portion of heating compartment 12.

Recognition unit 103 performs the recognition of an object such as a food item and the recognition of a bar code, a character, and the like attached to a food item or the like based on the image captured by imaging unit 19.

Recognition possibility determination unit 104 determines whether or not recognition unit 103 is in a state where recognition unit 103 can recognize heating control information described on a seal or the like of a food item by imaging unit 19.

That is, recognition possibility determination unit 104 determines whether or not recognition unit 103 can recognize heating control information based on whether or not recognition unit 103 can recognize quadrangular frame 30 which is a marker described later based on the image captured by imaging unit 19. To be more specific, when recognition possibility determination unit 104 determines that recognition unit 103 has recognized quadrangular frame 30, recognition possibility determination unit 104 determines that the image of the inside of heating compartment 12 can be captured by imaging unit 19. On the other hand, when recognition possibility determination unit 104 determines that recognition unit 103 has not recognized quadrangular frame 30, recognition possibility determination unit 104 determines that the image of the inside of heating compartment 12 cannot be captured by imaging unit 19.

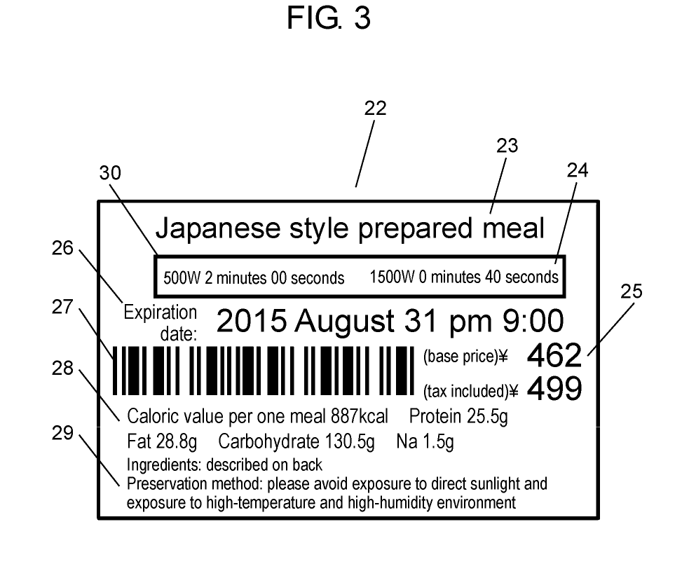

FIG. 3 is a view showing one example of product information including heating control information indicated on a product according to the first exemplary embodiment and the second exemplary embodiment of the present invention. Examples of product information including heating control information indicated on a product as shown in FIG. 3 include a seal attached to a food item and the like.

In heating compartment 12, products such as a prepared meal, a rice ball, a side dish, and the like are placed and heated. To these products, a seal which indicates above-mentioned heating power necessary for cooking a product, a heating time, and the like is attached respectively.

Information pieces for cooking such as a heating power, a heating time, and the like are referred to as heating control information in this exemplary embodiment.

On seal 22, information pieces such as product name 23, heating control information 24, price information 25, consumption time limit information 26, bar code 27 for specifying a product, nutrient information 28, and notification information 29 are indicated. In this exemplary embodiment, heating control information 24 is surrounded by quadrangular frame 30 such that heating control information 24 can be easily picked up from such information.

Further, on seal 22, a heating time when a product is heated at 500 W is indicated as a guide for heating a product with an ordinary household microwave oven, for example. Further, a heating time when a product is heated at 1500 W is also indicated as a guide for heating a product for a short time with large heating power for business use, for example. To be more specific, for example, seal 22 indicates “500 W: 2 minutes 00 seconds, 1500 W: 0 minutes 40 seconds”.

When a user opens door 3 and puts a food item in heating compartment 12, imaging unit 19 captures the image of the inside of heating compartment 12, recognition unit 103 recognizes a portion on which heating control information 24 is indicated based on the image captured by imaging unit 19 and recognizes characters, numbers, and the like which are heating control information 24.

To be more specific, recognition unit 103 recognizes quadrangular frame 30 based on the image captured by imaging unit 19.

Next, recognition unit 103 recognizes a string such as alphanumeric characters surrounded by quadrangular frame 30, for example, a string of “500 W200 1500 W040”.

Then, recognition unit 103 decomposes alphanumeric characters into a numeric string before “W”, a numeric string of three digits after “W”, a numeric string before “W” succeeding the numeric string of three digits, and a numeric string of three digits after “W” in accordance with a preset analytical rule, and recognizes the alphanumeric characters as “500”, “200”, “1500” and “040”, for example. Recognition unit 103 recognizes that, with respect to a second numeric string and a fourth numeric string, a first digit indicates “minute” and remaining two digits indicate seconds. Recognition unit 103 also recognizes that the first numeric string indicating heating power and the second numeric string indicating time correspond to each other, and a third numeric string indicating heating power and a fourth numeric string indicating time correspond to each other. That is, recognition unit 103 recognizes heating control information that a product should be heated at 500 W for two minutes or should be heated at 1500 W for 40 seconds.

When controller 100 includes heating condition determination unit 105, heating condition determination unit 105 determines a heating condition based on the image recognized by recognition unit 103. Heating condition determination unit 105 determines a heating condition corresponding to heating power with which heating controller 101 can control magnetron. For example, when heating controller 101 can control magnetron with heating power of 1500 W or more, heating condition determination unit 105 determines, as a heating condition, 1500 W which is larger heating power and forty seconds which is a heating time corresponding to the heating power of 1500 W in heating control information 24. When heating controller 101 can control magnetron only with heating power of less than 1500 W, heating condition determination unit 105 determines, as a heating condition, 500 W which is smaller heating power and two minutes which is a heating time corresponding to the heating power of 500 W in heating control information 24.

FIG. 4 is a plan view of a stirrer blade of the heating cooker according to one example of the exemplary embodiment of the present invention. As shown in FIG. 4, stirrer blades 14a, 14b are blades for stirring a microwave generated by a magnetron such that the microwave is distributed uniformly in the inside of heating compartment 12. Stirrer blades 14a, 14b are made of metal, for example.

As shown in FIG. 4, stirrer blades 14a, 14b are respectively configured such that a plurality of blade portions 21 extend radially from a rotary shaft. For example, as shown in FIG. 4, stirrer blades 14a, 14b may be configured such that respective blade portions 21 have different shapes.

By rotating stirrer blade 14a, 14b having blade portions 21 of a complicated shape as shown in FIG. 4, a microwave is guided such that the microwave follows stirrer blade 14a, 14b, and a change occurs in the flow of microwave in a space of heating compartment 12 between a position where blade portion 21 exits and a position where blade portion 21 does not exist. Due to such a configuration, a microwave can be uniformly stirred in the inside of heating compartment 12 more efficiently.

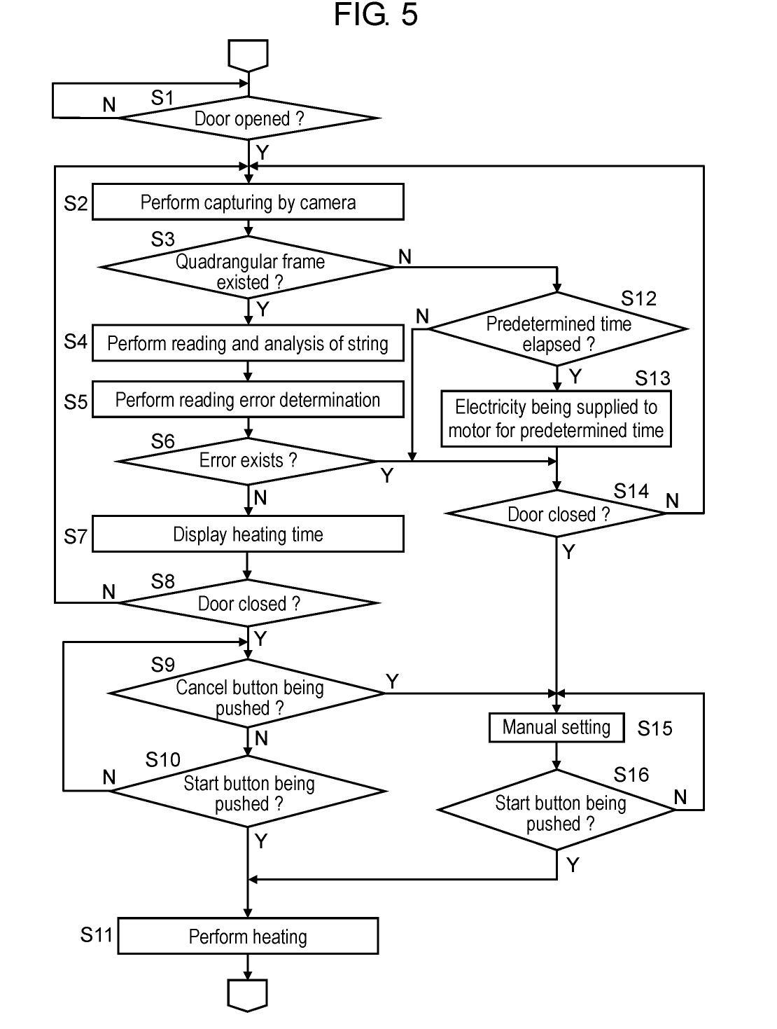

FIG. 5 is a flowchart showing a flow of an operation of the heating cooker according to the first exemplary embodiment of the present invention.

Hereinafter, the operation of the heating cooker according to this exemplary embodiment is described with reference to the flowchart shown in FIG. 5.

In step S1, when controller 100 determines that door 3 has been opened due to turning on (or off) of door switch 20, controller 100 advances processing to step S2. When controller 100 determines that door 3 has been opened, controller 100 starts counting of a predetermined time by a time counting unit (not shown in the drawing).

In step S2, controller 100 performs capturing of the image of the inside of heating compartment 12 by controlling imaging unit 19.

In step S3, when recognition unit 103 recognizes a quadrangular frame based on the image captured by imaging unit 19, controller 100 advances processing to step S4. When recognition unit 103 does not recognize a quadrangular frame based on the image captured by imaging unit 19, controller 100 advances processing to step S12.

In step S4, recognition unit 103 performs recognition (reading, analysis, and the like) of a string in the quadrangular frame.

To be more specific, recognition unit 103 recognizes a string such as alphanumeric characters and the like in quadrangular frame 30 which is a marker, for example. In the case of the seal shown in FIG. 3, recognition unit 103 recognizes a string of “500 W 200 1500 W 040”, and controller 100 analyzes and determines in accordance with a preset analysis rule that the string contains two heating control information 24, that is, heating control information that heating is performed at 500 W for two minutes and heating control information that heating is performed at 1500 W for forty seconds.

Next, in step S5, controller 100 starts the determination whether or not recognition unit 103 accurately recognizes the string, and in step S6, controller 100 determines whether or not recognition unit 103 accurately recognizes the string.

To be more specific, in heating control information 24, in the relationship with the first heating control information that heating is performed at 500 W for two minutes, controller 100 determines whether or not the second heating control information is inversely proportional to the first heating control information within a range of ±10%.

For example, in the above-mentioned example, while a heating power in the first heating control information is 500 W, a heating power in the second heating control information is 1500 W which is three times as large as the heating power of first heating control information. Since a heating time in the first heating control information is two minutes, provided that the heating time in the second heating control information falls within a range from 36 seconds to 44 seconds which is 40 seconds (one third of two minutes or three times inversely proportional to two minutes) ±10%, controller 100 determines that recognition unit 103 accurately recognizes a string.

In step S6, when controller 100 determines that recognition unit 103 accurately recognizes a string, controller 100 advances processing to step S7, and when controller 100 does not determine that recognition unit 103 accurately recognizes a string, controller 100 advances processing to step S14.

In step S7, controller 100 allows liquid crystal display unit 7 to display a time (for example, forty seconds) and the like for performing cooking which recognition unit 103 recognizes on liquid crystal display unit 7.

When controller 100 and heating controller 101 are formed of semiconductor elements separate from each other, controller 100 transmits, to heating controller 101, two kinds of heating control information 24, that is, heating control information that heating is performed for two minutes at 500 W and heating control information that heating is performed for forty seconds at 1500 W. When heating controller 101 can control a magnetron with 1500 W at maximum, controller 100 allows liquid crystal display unit 7 to display forty seconds thereon.

The ordinary household heating cooker and the business-use heating cooker differ from each other in power for heating. Accordingly, heating cookers can be manufactured at a low cost by manufacturing an ordinary household heating cooker and a business-use heating cooker such that both heating cookers use the same controller 100 in common and form respective heating controllers 101 using different semiconductor elements.

In step S8, when controller 100 determines that door 3 is closed based on a signal from door switch 20, controller 100 advances processing to step S9. When controller 100 does not determine that door 3 is closed, controller 100 returns processing to step S2.

When controller 100 determines that door 3 is not closed in step S8, there is a high possibility that reading of heating control information 24 has failed (error) so that a user has no intention of starting cooking by closing door 3. Accordingly, controller 100 determines that reading of heating control information 24 has failed (error), and returns processing to step S2.

In step S9, when controller 100 determines that cancel button 10 is pushed, controller 100 advances processing to step S15. When controller 100 does not determine that cancel button 10 is pushed, controller 100 advances processing to step S10.

With such a configuration, when a user determines that reading of heating control information has failed by recognizing a heating time displayed on liquid crystal display unit 7, or when a user wants to heat a food item with a different heating time or the like, by pushing cancel button 10, a user can perform cooking under a heating condition different from a heating condition recognized by recognition unit 103.

In step S10, when controller 100 determines that heating start button 9 has been pushed, controller 100 advances processing to step S11 so that heating is started. When controller 100 does not determine that heating start button 9 is pushed, controller 100 returns processing to step S9.

In step S12, when controller 100 determines that a predetermined time elapses from a point of time that door 3 has been opened, controller 100 advances processing to step S13. When controller 100 does not determine that a predetermine time elapses from a point of time when door 3 has been opened, controller 100 advances processing to step S14.

A predetermined time in step S12 means a time (for example, two to five seconds) from a point of time that door 3 has been opened to a point of time that a food item such as a prepared meal is placed in the inside of heating compartment 12.

When recognition unit 103 cannot recognize quadrangular frame 30 even a predetermined time elapses, it is considered that blade portion 21 of stirrer blade 14a shown in FIG. 4 blocks a field of view of imaging unit 19.

Therefore, in step S13, after a lapse of predetermined time, controller 100 determines that heating control information 24 is not recognized by recognition possibility determination unit 104, supplies electricity to motor 15a by rotation controller 102 for a predetermined time so that stirrer blade 14a is rotated at a predetermined angle. With such an operation, it is possible to bring about a state where an area in front of imaging unit 19 is not blocked by blade portions 21 of stirrer blade 14a.

A predetermined angle may be determined corresponding to a shape of blade portion 21 of stirrer blade 14a. For example, as shown in FIG. 4, when four blades are arranged at equal intervals (every 90 degrees), it is preferable that a predetermined angle be set to 45 degrees. That is, it is preferable that a predetermined angle be set to an angle which is an approximately half of a mounting pitch (angle) of blades which blade portions 21 of stirrer blade 14a have. With such a setting, it is possible to bring about a state where an area in front of imaging unit 19 is not blocked by blade portion 21 of stirrer blade 14a with minimum rotation of the stirrer blade 14a.

An electricity supply time of motor 15a and a rotation angle are proportional to each other. For example, when electricity is supplied to motor 15a for 0.5 seconds, blade portion 21 can be rotated by 45 degrees. With such a configuration, when blade portion 21 of stirrer blade 14a blocks a field of view of imaging unit 19 in step S13, controller 100 causes (rotates) stirrer blade 14a to move to a position where blade portion 21 of stirrer blade 14a does not block a field of view of imaging unit 19.

In this exemplary embodiment, electricity is supplied to motor 15a for a predetermined time in step S13 so that stirrer blade 14a is rotated by a predetermined angle (for example, 45 degrees). However, the present invention may be configured such that stirrer blade 14a is rotated to a predetermined position. For example, a predetermined position is an initial position (for example, a position of stirrer blade 14a at the time of shipping from a factory or at the time of initially supplying a power source, or is a position where blade portion 21 of stirrer blade 14a does not block an area in front of imaging unit 19 (the inside of the heating compartment). However, in this case, it is necessary to measure an angle that the stirrer blade 14a is rotated in total or how many times stirrer blade 14a is rotated in total from the shipping of a product from a factory or from starting the use of a product. The predetermined position is a preset position where blade potion 21 of stirrer blade 14a does not block a field of view of imaging unit 19.

When a predetermined time is not elapsed in step S12, a case is considered where a user has not yet put food item 6 such as a prepared food in heating compartment 12. Accordingly, when a predetermined time is not elapsed in step S12, controller 100 advances processing to step S14 by skipping step S13.

Further, also when controller 100 determines that a recognized string is an error in step S6, controller 100 advances processing to step S14. In step S14, controller 100 determines whether or not door 3 has been closed. When controller 100 determines that door 3 is closed, controller 100 advances processing to step S15. On the other hand, when controller 100 determines that door 3 is not closed, controller 100 returns processing to step S2, and the image of the inside of heating compartment 12 is captured by imaging unit 19.

When controller 100 determines that cancel button 10 has been pushed in step S9 or when controller 100 determines that door 3 has been closed in step S14, controller 100 advances processing to step S15. In step S15, controller 100 receives an input that a heating time has been manually set.

With such an operation, also when a food item on which heating control information 24 is not indicated is heated and when heating control information 24 cannot be recognized by recognition unit 103 at all due to smears or the like, a user can set a heating time and the like using a group of time setting buttons 8.

In step S16, when controller 100 determines that heating start button 9 has been pushed, controller 100 advances processing to step S11. When controller 100 does not determine that heating start button 9 has been pushed, controller 100 returns processing to step S15.

As has been described heretofore, according to the heating cooker (microwave oven 1) of this exemplary embodiment, a heating time can be automatically set by a store employee without inputting a heating time of a product or selecting a button corresponding to the product.

Further, the heating cooker of this exemplary embodiment is configured such that rotation controller 102 controls the position of blade portions 21 such that blade portions 21 do not obstruct the capturing at the time of capturing the image of the inside of heating compartment 12 by imaging unit 19. Accordingly, a burden imposed on the store employee to rotate blade portions 21 with hand or to rotate blade portions 21 by operating an inputting unit can be reduced.

### Second Exemplary Embodiment

Next, the heating cooker (microwave oven 1) according to the second exemplary embodiment of the present invention is described.

A point which makes the heating cooker according to the first exemplary embodiment and the heating cooker according to the second exemplary embodiment different from each other lies in that, in the heating cooker according to the second exemplary embodiment, controller 100 is configured such that recognition possibility determination unit 104 determines whether or not a field of view of imaging unit 19 is blocked by stirrer blade 14a after heating is finished, and when a field of view of imaging unit 19 is blocked by stirrer blade 14a, stirrer blade 14a is rotated by a predetermined angle by rotation controller 102.

With such a configuration, after heating is finished, a state is brought about where a field of view of imaging unit 19 is not blocked by stirrer blade 14a. Accordingly, when a user wants to heat another food item or the like after such heating, recognition unit 103 can smoothly recognize heating control information 24.

Accordingly, when a user opens door 3 and puts a food item into heating compartment 12 to newly perform heating, stirrer blade 14a is at a position where stirrer blade 14a does not obstruct a field of view of imaging unit 19. Accordingly, when the quadrangular frame is not found in step S3, it is unnecessary to move the motor or the like.

In this exemplary embodiment, a point which makes this exemplary embodiment different from the first exemplary embodiment is mainly described, and the description with respect to the same control as the control in the first exemplary embodiment is omitted.

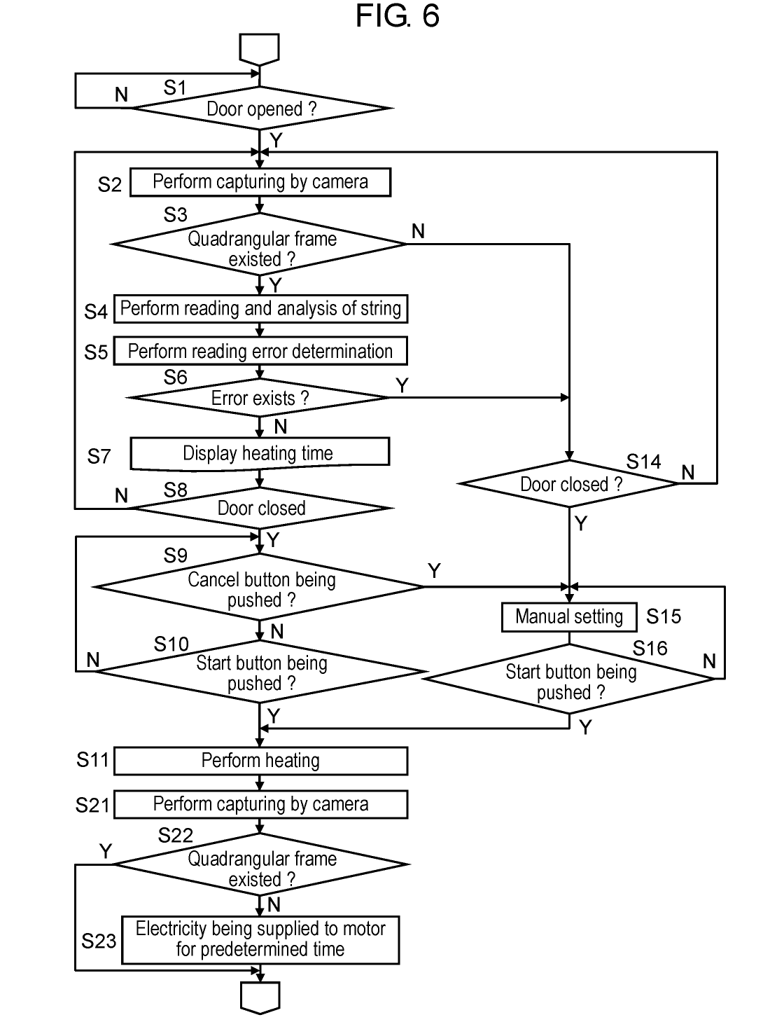

FIG. 6 is a flowchart showing a flow of operation of the heating cooker according to the second exemplary embodiment of the present invention. As shown in FIG. 6, in microwave oven 1 which is one example of the heating cooker according to the second exemplary embodiment of the present invention, when heating is finished in step S11, imaging unit 19 captures the image of the inside of heating compartment 12 in step S21, and controller 100 advances processing to step S22.

In step S22, recognition unit 103 performs recognition of quadrangular frame 30 based on the image captured in step S21. When the controller 100 determines that recognition unit 103 performs recognition of quadrangular frame 30, recognition possibility determination unit 104 determines that recognition unit 103 is in a state where recognition unit 103 can recognize heating control information 24, that is, a state where an area in front of imaging unit 19 is not blocked by blade portions 21, and controller 100 finishes processing. With such an operation, microwave oven 1 is brought into a stand-by state.

On the other hand, when the controller 100 determines that recognition unit 103 cannot perform recognition of quadrangular frame 30, recognition possibility determination unit 104 determines that recognition unit 103 is in a state where recognition unit 103 cannot recognize heating control information 24, that is, a state where a field of view (a field of view for capturing an object to be captured) of imaging unit 19 is blocked by blade portions 21, and controller 100 advances processing to step S23.

In step S23, controller 100 brings about a state where imaging unit 19 can capture a food item by rotating stirrer blade 14a by a predetermined angle (for example 45 degrees) by controlling motor 15a using rotation controller 102.

An electricity supply time of motor 15a and a rotation angle are proportional to each other. For example, when electricity is supplied to motor 15a for 0.5 seconds, blade portion 21 can be rotated by 45 degrees. With such an operation, when blade portions 21 of stirrer blade 14a block a field of view of imaging unit 19 in step S13, controller 100 causes stirrer blade 14a to move to a position where blade portion 21 of stirrer blade 14a does not block a field of view of imaging unit 19.

In this exemplary embodiment, stirrer blade 14a is rotated by a predetermined angle (for example, 45 degrees) in step 23. However, the heating cooker according to the present invention may be configured such that stirrer blade 14a is rotated to a predetermined position (for example, as an initial position, a position of stirrer blade 14a at the time of shipping from a factory or at the time of initially supplying a power source, or a position where blade portion 21 of stirrer blade 14a does not block an area in front of imaging unit 19). However, in this case, it is preferable to count an angle that stirrer blade 14a rotates in total or how many times stirrer blade 14a rotates in total from the shipping of a product from a factory or from the starting of use of a product.

Besides the above-mentioned configuration, a point which makes the first exemplary embodiment and the second exemplary embodiment different from each other lies in that, in the second exemplary embodiment, when the controller 100 determines that recognition unit 103 cannot recognize the quadrangular frame in step S3, controller 100 advances processing to step S14, and controller 100 determines whether or not door 3 has been opened.

As described above, in the second exemplary embodiment, controller 100 is configured such that controller 100 determines whether or not recognition of quadrangular frame 30 can be performed by recognition unit 103 after heating (step S11) is finished, and blade portion 21 is brought into a state where blade portion 21 does not block an area in front of imaging unit 19 by rotating stirrer blade 14a by a predetermined angle using rotation controller 102 (step S23) when recognition of quadrangular frame 30 cannot be performed (No in step S22). With such a configuration, when a user intends to put a food item in the inside of heating compartment 12 and to heat the food item by opening door 3 as a succeeding step (step S1), it is possible to bring about a state where a field of view of imaging unit 19 is not blocked by stirrer blade 14a. With such a configuration, when a user puts a food item in the inside of heating compartment 12 and heats the food item as a succeeding step, it is unnecessary to perform recognition operation whether or not recognition unit 103 can perform recognition of quadrangular frame 30 and hence, heating compartment 12 can immediately perform heating operation.

As has been described heretofore, according to the heating cooker (microwave oven 1) of this exemplary embodiment, a heating time can be automatically set by a store employee without inputting a heating time of a product or selecting a button corresponding to the product.

Further, the heating cooker of this exemplary embodiment is configured such that rotation controller 102 controls positions of blade portions 21 such that blade portion 21 does not obstruct the heating operation after heating by the heating unit and hence, a burden imposed on the store employee to rotate blade portions 21 with hand or to rotate blade portions 21 by operating the inputting unit can be reduced.

As described above, in this exemplary embodiment, recognition possibility determination unit 104 determines whether or not quadrangular frame 30 which is a marker can be recognized based on the image captured by imaging unit 19. The description has been made by taking, as an example, the heating cooker where whether or not blade portion 21 of stirrer blade 14a is within a field of view of imaging unit 19 is determined based on the result of such a determination. However, a method and a configuration of determining whether or not blade portion 21 of stirrer blade 14a is within a field of view of imaging unit 19 are not limited to the above-mentioned method and configuration.

For example, in another method and configuration, a light emitting element and a light receiving element are arranged in a vicinity of stirrer blade 14a (for example, at a position where blade portions 21 is sandwiched by light emitting element and light receiving element). When the light receiving element cannot receive light from the light emitting element, the recognition possibility determination unit may determine that blade portion 21 of stirrer blade 14a is within a field of view of imaging unit 19. Further, the heating cooker may be also configured such that only a light receiving element is arranged in a vicinity of stirrer blade 14a, and when an intensity of light which the light receiving element receives is weakened, the recognition possibility determination unit determines that blade portion 21 of stirrer blade 14a is within a field of view of imaging unit 19.

Alternatively, the heating cooker may be configured such that when recognition unit 103 recognizes stirrer blade 14a based on the image captured by imaging unit 19, recognition possibility determination unit 104 determines that blade portion 21 of stirrer blade 14a is within a field of view of imaging unit 19.

Further, the heating cooker may be configured such that a rotating position of stirrer blade 14a or motor 15a is detected by a Hall element or the like, for example.

In the above-mentioned embodiment, recognition unit 103 is configured to recognize a string printed on seal 22 for recognizing a heating condition. However, recognition unit 103 is also applicable to reading of a bar code or the like printed on a seal. Further, the heating cooker may be configured to recognize kinds and amounts of rice and side dishes, for example, based on an image of a product without relying on symbolized information such as a bar code and a string, and to recognize a heating condition based on the recognized kinds and amounts of rice and side dishes.

In this exemplary embodiment, as shown in FIG. 4, stirrer blade 14a of a shape having a plurality of blade portions 21 is exemplified. However, stirrer blade 14a may have other shapes such as a circular shape or a triangular shape. For example, stirrer blade 14a may have a circular shape, and a groove, a hole, or the like may be formed in circular-shaped stirrer blade 14a. In this exemplary embodiment, blade portions 21 are portions which stirrer blade 14a has, and are portions defined by excluding spaces such as grooves or holes formed in stirrer blade 14a.

In this exemplary embodiment, the configuration is exemplified where recognition possibility determination unit 104 and recognition unit 103 are disposed in the inside of the heating cooker. However, the heating cooker may be configured to be connectable with other communication terminals or networks by using wired or wireless communication, and an external server or the like may perform functions that controller 100 of this exemplary embodiment (for example, recognition possibility determination unit 104, recognition unit 103, and the like) has in place of controller 100. The heating cooker may be configured such that information processed by recognition possibility determination unit 104, recognition unit 103 and the like is transmitted to a server through a network, and processing executed by recognition possibility determination unit 104, recognition unit 103 and the like is executed on a server side. In this case, the heating cooker may be configured to control stirrer blade 14a such that stirrer blade 14a is rotated by a predetermined angle or is moved to a predetermined position based on a result of processing transmitted from the server.

As has been described heretofore, the heating cooker according to one example of the exemplary embodiment of the present invention includes: the heating compartment; the magnetron which outputs a microwave; the stirrer blade having the blade portions for stirring the microwave; the imaging unit for capturing the image of the inside of the heating compartment; and the controller having a function of recognizing the image captured by the imaging unit. The controller is configured to perform a control of rotating the stirrer blade by a predetermined angle or moving the stirrer blade to a predetermined position based on the image captured by the imaging unit.

With such a configuration, in a state where the stirrer blade blocks a field of view of the imaging unit when the image of the inside of the heating compartment is captured by the imaging unit before heating, it is possible to bring about a state where the image of the inside of the heating compartment can be captured by the imaging unit by rotating the stirrer blade. With such a configuration, a product, a character, or the like placed in the inside of the heating compartment can be captured with more certainty. Accordingly, it is unnecessary for a user to perform a cumbersome operation such as setting of a heating time or the like.

Further, the heating cooker according to one example of the exemplary embodiment of the present invention may be configured to control the stirrer blade such that the stirrer blade is rotated by a predetermined angle or is moved to a predetermined position when the controller determines that the blade portion of the stirrer blade is in a field of view of the imaging unit based on the image captured by the imaging unit. With such a configuration, in a state where the stirrer blade blocks a field of view of the imaging unit when an image of the inside of the heating compartment is captured by the imaging unit before heating, it is possible to bring about a state where the image of the inside of the heating compartment can be captured by the imaging unit by rotating the stirrer blade. With such a configuration, a product, a character, or the like placed in the inside of the heating compartment can be captured with more certainty. Accordingly, it is unnecessary for a user to perform a cumbersome operation such as setting of a heating time or the like.

Further, the heating cooker according to one example of the exemplary embodiment of the present invention may be configured to control the stirrer blade such that the stirrer blade is rotated by a predetermined angle or is moved to an initial position when the controller cannot recognize heating control information based on the image captured by the imaging unit.

With such a configuration, in a state where the stirrer blade blocks a field of view of the imaging unit when an image of the inside of the heating compartment is captured by the imaging unit before heating, it is possible to bring about a state where the image of the inside of the heating compartment can be captured by the imaging unit by rotating the stirrer blade. With such a configuration, a product, a character, or the like placed in the inside of the heating compartment can be captured with more certainty. Accordingly, it is unnecessary for a user to perform a cumbersome operation such as setting of a heating time or the like.

Further, the heating cooker according to one example of the exemplary embodiment of the present invention is configured to control the stirrer blade such that the stirrer blade is rotated by a predetermined angle or is moved to a predetermined position when the controller cannot recognize a specific character or a specific diagram based on the image captured by the imaging unit. With such a configuration, in a state where the stirrer blade blocks an area in front of the imaging unit when the image of the inside of the heating compartment is captured by the imaging unit before heating, it is possible to bring about a state where the image of the inside of the heating compartment can be captured by the imaging unit by rotating the stirrer blade. With such a configuration, a product, a character, or the like placed in the inside of the heating compartment can be captured with more certainty. Accordingly, it is unnecessary for a user to perform a cumbersome operation such as setting of a heating time or the like.

In the heating cooker according to one example of the exemplary embodiment of the present invention, the stirrer blade, the magnetron, and the imaging unit may be arranged on a ceiling portion of the heating compartment. With such a configuration, in a state where the stirrer blade arranged on the ceiling portion blocks an area in front of the imaging unit when the image of the inside of the heating compartment is captured by the imaging unit arranged on the ceiling portion before heating, it is possible to bring about a state where the image of the inside of the heating compartment can be captured by the imaging unit arranged on the ceiling portion by rotating the stirrer blade arranged on the ceiling portion. With such a configuration, a product, a character, or the like placed in the inside of the heating compartment can be captured with more certainty. Accordingly, it is unnecessary for a user to perform a cumbersome operation such as setting of a heating time or the like.

The heating cooker according to one example of the exemplary embodiment of the present invention may be configured such that the imaging unit captures the image of the inside of the heating compartment before starting heating cooking or after finishing heating cooking. With such a configuration, in a state where the stirrer blade blocks an area in front of the imaging unit when the image of the inside of the heating compartment is captured by the imaging unit before starting heating cooking, it is possible to bring about a state where the image of the inside of the heating compartment can be captured by the imaging unit by rotating the stirrer blade. When capturing is performed after finishing heating cooking, it is unnecessary to perform the positional adjustment of the stirrer blade at the time of starting next heating cooking, thus shortening a cooking time.

The heating cooker according to one example of the exemplary embodiment of the present invention includes: the heating compartment in which a food item is stored; the magnetron which generates a microwave in the inside of the heating compartment; and the imaging unit which captures the image of the inside of the heating compartment. Further, the heating cooker may include: the stirrer blade disposed below the imaging unit and having blade portions for stirring a microwave in the inside of the heating compartment; the motor for rotating the stirrer blade; and the rotation controller which controls rotation of the motor. The heating cooker further includes: the recognition unit which recognizes the image captured by the imaging unit; the heating condition determination unit which determines a heating condition based on the image recognized by the recognition unit; and the heating controller which controls the magnetron in accordance with a heating condition determined by the heating condition determination unit. Further, the heating cooker is configured such that when the imaging unit captures the image of the inside of the heating compartment and the controller 100 determines that the blade portion of the stirrer blade blocks an area in front of the imaging unit, the rotation controller rotates the stirrer blade by a predetermined angle.

With such a configuration, in a case where the image of the inside of the heating compartment is captured by the imaging unit before heating and the controller 100 determines that the stirrer blade blocks an area in front of the imaging unit based on the captured image, it is possible to bring about a state where the image of the inside of the heating compartment can be captured by the imaging unit by rotating the stirrer blade. With such a configuration, a product, a character, or the like placed in the inside of the heating compartment can be captured with more certainty. Accordingly, it is unnecessary for a user to perform a cumbersome operation such as setting of a heating time or the like.

The heating cooker according to one example of the exemplary embodiment of the present invention includes: the heating compartment in which a food item is stored; the magnetron which generates a microwave in the inside of the heating compartment; the imaging unit which captures the image of the inside of the heating compartment; and the stirrer blade which is disposed below the imaging unit and has the blade portions for stirring a microwave in the inside of the heating compartment. The heating cooker further includes: the motor for rotating the stirrer blade; the rotation controller for controlling rotation of the motor; the recognition unit for recognizing the image captured by the imaging unit; and the heating condition determination unit which determines a heating condition based on the image recognized by the recognition unit. The heating cooker further includes: the heating controller which controls the magnetron in accordance with a heating condition determined by the heating condition determination unit; and the controller. The heating cooker according to one example of the exemplary embodiment of the present invention may be configured such that the imaging unit captures the image of the inside of the heating compartment, the recognition unit recognizes the image captured by the imaging unit, and the controller determines whether or not the stirrer blade is rotated by a predetermined angle by the rotation controller based on the result of recognition of the recognition unit. With such a configuration, in a state where the stirrer blade blocks an area in front of the imaging unit when the image of the inside of the heating compartment is captured by the imaging unit before heating, it is possible to bring about a state where the image of the inside of the heating compartment can be captured by the imaging unit by rotating the stirrer blade. With such a configuration, a product, a character, or the like placed in the inside of the heating compartment can be captured with more certainty. Accordingly, it is unnecessary for a user to perform a cumbersome operation such as setting of a heating time or the like.

Further, in the heating cooker according to one example of the exemplary embodiment of the present invention, the controller may be configured such that when the controller determines that the recognition unit cannot recognize an image or a character relating to a heating condition, the stirrer blade is rotated by a predetermined angle by the rotation controller. With such a configuration, in a state where the stirrer blade blocks an area in front of the imaging unit when the image of the inside of the heating compartment is captured by the imaging unit before heating, it is possible to bring about a state where the image of the inside of the heating compartment can be captured by the imaging unit by rotating the stirrer blade. With such a configuration, a product, a character, or the like placed in the inside of the heating compartment can be captured with more certainty. Accordingly, it is unnecessary for a user to perform a cumbersome operation such as setting of a heating time or the like.

### INDUSTRIAL APPLICABILITY

As has been described heretofore, the present invention can provide a heating cooker which can recognize a heating time and heating power of a product by an imaging unit while arranging the imaging unit in a vicinity of the center of a ceiling in the inside of a heating compartment. Accordingly, the present invention is widely applicable to a heating cooker such as a household microwave oven besides a microwave oven used in sales stores.

### REFERENCE MARKS IN THE DRAWINGS

1: microwave oven (heating cooker)

2: casing

3: door

4: glass window

5: handle

6: operation display part

7: liquid crystal display unit

8: group of time setting buttons

9: heating start button

10: cancel button

11: temporarily stop button

12: heating compartment

13a, 13b: magnetron (heating unit)

14a, 14b: stirrer blade

15a, 15b: motor

16: food item

19: camera (imaging unit)

20: door switch

21: blade portion

22: seal

23: product name

24: heating control information

25: price information

26: consumption limit information

27: bar code

28: nutrient information

29: notification information

30: quadrangular frame (marker)

100: controller

101: heating controller

102: rotation controller

103: recognition unit

104: recognition possibility determination unit

105: heating condition determination unit

1. A heating cooker comprising:
a heating compartment;
a magnetron configured to output a microwave into an inside of the heating compartment;
a stirrer blade which is configured to stir the microwave and has a blade portion;
an imaging unit configured to capture an image of the inside of the heating compartment; and
a controller having a function of recognizing the image captured by the imaging unit,
wherein the controller is configured to control the stirrer blade based on the image captured by the imaging unit such that the stirrer blade is rotated by a predetermined angle or is moved to a predetermined position.

2. The heating cooker according to claim 1, wherein the controller is configured to control the stirrer blade such that the stirrer blade is rotated by the predetermined angle or is moved to the predetermined position when the controller determines that the blade portion of the stirrer blade exists between the imaging unit and an object to be captured based on the image captured by the imaging unit.

3. The heating cooker according to claim 1, wherein the controller is configured to control the stirrer blade such that the stirrer blade is rotated by the predetermined angle or is moved to the predetermined position when the controller is not capable of determining a heating condition based on the image captured by the imaging unit.

4. The heating cooker according to claim 1, wherein the controller is configured to control the stirrer blade such that the stirrer blade is rotated by the predetermined angle or is moved to the predetermined position when the controller determines that a specific character or a specific diagram is not recognizable based on the image captured by the imaging unit.

5. The heating cooker according to claim 1, wherein the stirrer blade and the imaging unit are arranged on a ceiling side of the heating compartment.

6. The heating cooker according to claim 1, wherein the imaging unit is configured to perform capturing at least at either timing before starting heating cooking or timing after finishing heating cooking.

7. The heating cooker according to claim 1, further comprising:
a motor configured to rotate the stirrer blade;
a rotation controller configured to control rotation of the motor;
a recognition unit configured to recognize the image captured by the imaging unit;
a heating condition determination unit configured to determine a heating condition based on the image recognized by the recognition unit; and
a heating controller configured to control the magnetron in accordance with the heating condition determined by the heating condition determination unit,
wherein in capturing the image of the inside of the heating compartment by the imaging unit, when the controller determines that the blade portion of the stirrer blade blocks a field of view of the imaging unit, the rotation controller is configured to rotate the stirrer blade by the predetermined angle.

8. The heating cooker according to claim 7, further comprising a controller configured to determine whether or not the stirrer blade is to be rotated by the predetermined angle by the rotation controller based on the image recognized by the recognition unit.

9. The heating cooker according to claim 8, wherein the controller is configured to rotate the stirrer blade by the predetermined angle by the rotation controller when the controller determines that the recognition unit is not capable of recognizing the image or a character relating to the heating condition.
